(19) United States
(12) Patent Application Publication
(10) Pub. No.: US 2026/0171500 A1
(43) Pub. Date: Jun. 18, 2026

(54) ELECTROLYTE FOR LITHIUM METAL BATTERY AND LITHIUM METAL BATTERY INCLUDING THE SAME

(71) Applicants: HYUNDAI MOTOR COMPANY, SEOUL (KR); KIA CORPORATION, SEOUL (KR); KOREA ADVANCED INSTITUTE OF SCIENCE AND TECHNOLOGY, Daejeon (KR)

(72) Inventors: Eunji Kwon, Hwaseong-si (KR); Ji Yong Lee, Hwaseong-si (KR); Sangheon Lee, Hwaseong-si (KR); Samuel Seo, Hwaseong-si (KR); Yeonjong Oh, Hwaseong-si (KR); Kyuju Kwak, Hwaseong-si (KR); Dong Hyun Lee, Hwaseong-si (KR); Sangsu Lee, Hwaseong-si (KR); Kyoung Han Ryu, Hwaseong-si (KR); Jiho Lim, Hwaseong-si (KR); Nam-Soon Choi, Daejeon (KR); Jeong-A Lee, Daejeon (KR); Haneul Kang, Daejeon (KR)

(73) Assignees: HYUNDAI MOTOR COMPANY, SEOUL (KR); KIA CORPORATION, SEOUL (KR); KOREA ADVANCED INSTITUTE OF SCIENCE AND TECHNOLOGY, Daejeon (KR)

(21) Appl. No.: 19/420,714

(22) Filed: Dec. 15, 2025

(30) Foreign Application Priority Data
Dec. 16, 2024 (KR) 10-2024-0187313

(51) Int. Cl. H01M 10/0567; H01M 4/525; H01M 10/052; H01M 10/0568

(52) U.S. Cl. CPC H01M 10/0567; H01M 4/525; H01M 10/052; H01M 10/0568; H01M 2300/0025

(57) ABSTRACT

An electrolyte for a lithium metal battery that includes a lithium salt, a non-aqueous organic solvent, and a thiophene additive, wherein the thiophene additive is included in an amount of 0.5 wt % to 3 wt % based on a total amount (100 wt %) of the electrolyte for a lithium metal battery.

### CROSS-REFERENCE TO RELATED APPLICATION

This application claims priority to and the benefit of Korean Patent Application No. 10-2024-0187313 filed with the Korean Intellectual Property Office on Dec. 16, 2024, the entire contents of which are incorporated herein by reference.

### FIELD

The disclosure relates to an electrolyte for a lithium metal battery and a lithium metal battery including the same.

### BACKGROUND

As the electric vehicle market grows, there is an increasing need for high-capacity batteries that can outperform state of the art lithium ion batteries. Accordingly, there is an increasing demand for negative and positive electrode materials with high energy density, and providing for high energy density and long-term stability of the lithium metal batteries.

Lithium metal has a high capacity per weight of 3,860 mAh/g and a low standard electrode potential (−3.04 V vs normal hydrogen electrode), which has led to its use as a negative electrode material for lithium secondary batteries. However, lithium metal is highly reactive, creating an extremely reducing atmosphere during the charging process, which may cause an irreversible decomposition reaction between the lithium metal and an electrolyte. The decomposition reaction may deplete the electrolyte, and the decomposition reaction products may form a non-uniform film on the lithium metal surface. In addition, lithium can grow and form dendrites, as charging and discharging cycles are repeated. This dendritic lithium causes electrical short circuits inside the batteries, leading to battery safety issues such as fires, explosions, and the like.

The disclosure provides high stability and high capacity lithium metal batteries by developing an electrolyte that can reduce, prevent, and/or alleviate reactivity of lithium metal, can prevent dendritic lithium growth, and can enable uniform lithium electrodeposition (plating).

### SUMMARY

An aspect of the disclosure provides an electrolyte for a lithium metal battery capable of improving stability not only at the lithium metal interface but also at the positive electrode interface.

In another aspect, the disclosure provides a lithium metal battery including the electrolyte in accordance with the aspects and embodiments described herein, a thin film lithium negative electrode, and a high loading high Ni nickel-cobalt-manganese positive electrode, and which exhibits excellent cycle-life performance.

An electrolyte for a lithium metal battery according to an embodiment includes a lithium salt; a non-aqueous organic solvent; and a thiophene additive; wherein the thiophene additive is included in an amount of 0.5 wt % to 3 wt % based on a total amount (100 wt %) of the electrolyte for a lithium metal battery.

In embodiments, the thiophene additive may be included in an amount of 1 wt % based on the total amount (100 wt %) of the electrolyte for a lithium metal battery.

In embodiments, the non-aqueous organic solvent may include FSA.

In embodiments, the lithium salt may include at least one selected from LiFSI, LiFNFSI, and LiTFSI.

In embodiments, the concentration of the lithium salt included in the electrolyte may be in a range from 2.0 M to 4.0 M.

According to another embodiment, a lithium metal battery may include a positive electrode; a lithium metal layer as a negative electrode facing the positive electrode; a separator interposed between the positive electrode and the negative electrode; and the electrolyte for the lithium metal battery in accordance with the disclosure.

In embodiments, the lithium metal layer may be formed by the charging and discharging of the lithium metal battery.

In embodiments, the lithium metal layer may have a thickness of 5 μm to 50 μm.

In embodiments, the positive electrode may include a lithium-nickel-manganese-cobalt-based metal oxide.

In embodiments, the positive electrode may include a positive electrode active material including a lithium-nickel-manganese-cobalt-based metal oxide, wherein the nickel may be included in an amount of greater than or equal to 80 wt % based on a total amount (100 wt %) of the positive electrode active material.

In embodiments, the nickel may be included in an amount of greater than or equal to 89 wt % based on a total amount (100 wt %) of the positive electrode active material.

The electrolyte for a lithium metal battery according to an embodiment improves the stabilization of a lithium metal interface, and can also improve the structural stability of a positive electrode by introducing a thiophene additive, which can allow the lithium metal battery comprising the electrolyte to exhibit excellent cycle-life performance and stable coulombic efficiency, in particular when compared to state of the art lithium metal batteries.

### BRIEF DESCRIPTION OF THE DRAWINGS

FIG. 1 depicts a non-limiting mechanism through which thiophene additive stabilizes the lithium metal and the surface of the positive electrode.

FIGS. 2A to 2C show the results of evaluating cycle-life characteristics of lithium metal battery cells using each electrolyte according to Examples 1 to 4 and Comparative Example 1.

FIG. 3 shows the results of LSV (Linear Sweep Voltammetry) evaluation of the lithium metal battery cells using each electrolyte according to Examples 2 to 4 and Comparative Example 1.

FIG. 4 is a graph showing the initial efficiency of the lithium metal battery cells using each electrolyte according to Example 2 and Comparative Example 1 (FIG. 4A) and an enlarged graph of the 0 to 0.3 mV section (FIG. 4B).

FIG. 5A is an SEM image of the electrodeposited lithium surface of a lithium metal battery using the electrolyte according to Comparative Example 1. FIG. 5B is an SEM image of the electrodeposited lithium surface of a lithium metal battery using the electrolyte according to Example 1. FIG. 5C is an SEM image of a cross-section of the electrodeposited lithium of a lithium metal battery using the electrolyte according to Comparative Example 1. FIG. 5D is an SEM image of the electrodeposited lithium surface of a lithium metal battery using the electrolyte according to Example 1.

FIG. 6 is a graph showing the evaluation of the critical current density of the lithium metal battery cells using each electrolyte according to Example 1 and Comparative Example 1, and an enlarged graph showing the area around the current density of mA·cm⁻².

FIG. 7 is a graph showing the evaluation of the limiting specific capacity of a lithium metal battery cell using the electrolyte according to Example 1 and Comparative Example 1, and an enlarged graph showing the area around the specific capacity of 4 mAh·cm⁻².

FIG. 8 is a graph showing the results of evaluating the cycle performance of the lithium metal battery cells using each electrolyte according to Example 1 and Comparative Example 1.

FIG. 9 is a graph showing the results of Li corrosion evaluation of the lithium metal battery cells using each electrolyte according to Example 1 and Comparative Example 1.

FIG. 10 is a graph showing the results of dark current evaluation of the lithium metal battery cells using each electrolyte according to Example 1 and Comparative Example 1.

FIG. 11 is a graph showing the results of a high-rate discharge evaluation of the lithium metal battery cells using each electrolyte according to Example 1 and Comparative Example 1.

FIG. 12A is an SEM image after high-rate discharge evaluation of the lithium metal battery cell using the electrolyte according to Comparative Example 1, and FIG. 12B is an SEM image after high-rate discharge evaluation of the lithium metal battery cell using the electrolyte according to Example 1.

FIG. 13 is a graph showing the results of EIS (Electrochemical Impedance Spectroscopy) analysis of the lithium metal battery cells using each electrolyte according to Example 1 and Comparative Example 1.

FIG. 14 is a graph showing the results of evaluating cycle-life characteristics of lithium metal battery cells using electrolytes according to Example 1 and Comparative Example 1.

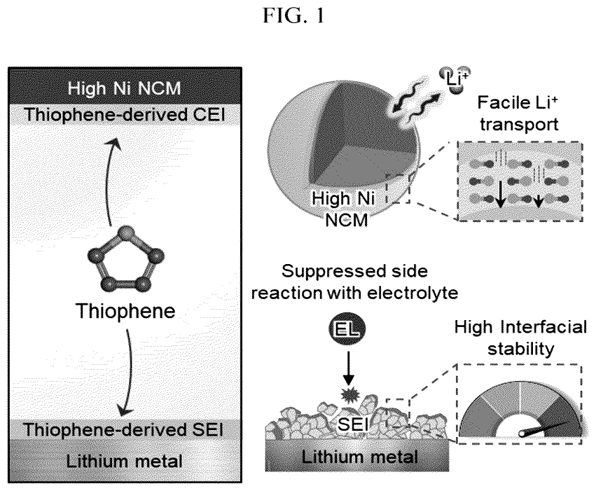

### DETAILED DESCRIPTION

The above and other objects, features and advantages of the present disclosure will be more clearly understood from the following aspects and embodiments taken in conjunction with the accompanying drawings. However, neither the present disclosure nor the claims are limited to the embodiments disclosed herein, and may be modified into different forms in accordance with the guidance provided herein. The example aspects and embodiments are provided herein in an effort to thoroughly explain the various features of the disclosure and to convey the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise” or “comprising”, “include” or “including”, “have” or “having”, etc., when used in this specification, specify the presence of stated features, integers, steps, operations, elements, components, or combinations thereof, but do not preclude the presence or addition of one or more other features, integers, steps, operations, elements, components, or combinations thereof. In some aspects and embodiments, these terms should be understood to encompass the terms “consisting of” and “consisting essentially of” which refer to features, integers, numbers, steps, operations, elements, components, parts, or combinations thereof that only include the recited components, or the recited components allowing for minor amounts of other components or elements that do not have a material effect on the function of the recited feature, component, embodiment, or aspect of the disclosure. Thus, some aspects and embodiments may refer to these various transitionary terms, all of which form part of the disclosure.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used or implied herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

When any part of or referred to as being “on”, “over” the other part, which might be directly on or over the other parts or may be a different part involves therebetween. On the contrary, when any part is mentioned as being “directly on” the other parts, the other part is not interposed therebetween.

As used herein, the term “combination(s) thereof” described in a recited list of non-limiting elements, components, and/or options, whether or not in a Markush format, refers to a mixture or combination that include one or more element(s), component(s), and/or option(s) recited in the list, and can include combinations including at least one of the recited list in combination with one or more other elements, components, and/or options.

Hereinafter, various aspects and embodiments will be described more fully, as non-limiting exemplary embodiments of the disclosure and merely for purposes of illustration and clarity. Those skilled in the art will appreciate that the described embodiments may be modified in various different ways, all without departing from the spirit or scope of the disclosure.

### <Electrolyte for Lithium Metal Battery>

A typical state of the art lithium metal battery based on a thin film lithium metal and a high-loading high Ni nickel-cobalt-manganese (NCM) positive electrode, include charge/discharge cycles which progress through a electrodeposition/desorption process incorporating a large amount of lithium ions on the lithium metal surface. Furthermore, when the positive electrode has a Ni content of greater than or equal to 80%, Ni⁴⁺ cations are reduced to the more stable Ni²⁺ cation, through a redox reaction, gaining electrons from the electrolyte. This causes an oxidation decomposition of the electrolyte and structural degradation (e.g., cation mixing, microcracking) of the positive electrode.

The various aspects and embodiments provided by the disclosure relate to an electrolyte for a lithium metal battery, which is capable of not only stabilizing the lithium metal interface but also improving the stability of the positive electrode interface by introducing a thiophene additive to the electrolyte. This results in batteries that exhibit excellent cycle-life characteristics as well as stable coulombic efficiency, when compared to an electrolyte composition that lacks a thiophene additive.

In additional embodiments, the disclosure relates to a lithium metal battery based on a 20 μm lithium thin film and a high-loading high Ni nickel-cobalt-manganese (NCM) positive electrode having excellent cycle-life performance, even under conditions that include a high-loading high Ni NCM positive electrode (4 mAh cm⁻²) with an Ni content of greater than or equal to about 80% such as, for example, greater than or equal to about 89% based on a total amount of a positive electrode active material, and with injecting a small amount (1.5 mg mAh⁻¹) of an electrolyte.

As discussed above, lithium metal has high capacity (2,060 mAh cm⁻³, 3,860 mAh g⁻¹) per unit volume and weight, and can provide for a high energy density secondary battery. However, lithium metal can cause fast capacity deterioration and poor cycle-life performance, e.g., by electrochemical decomposition of the electrolyte due to low stability and high reactivity, which makes the technology difficult to commercialize.

Similarly, a high Ni NCM battery advantageously provides high energy, but the high nickel content can problems relating to transition metal elution, cation mixing, low thermal stability, surface degradation and degradation of performance characteristics due to residual lithium, and the like.

Accordingly, the aspects and embodiments described herein introduce a thiophene additive to the electrolyte. The addition can improve structural stability of the positive electrode as well as stabilize the lithium metal interface, providing lithium metal batteries that exhibit stable coulombic efficiency as well as excellent cycle-life performance, compared to a lithium metal battery having an electrolyte composition that lacks any thiophene additive.

In accordance with the disclosure, the thiophene additive may be a thiophene compound as described herein or as otherwise generally known in the art.

The electrolyte for a lithium metal battery according to an embodiment includes a lithium salt; a non-aqueous organic solvent; and a thiophene additive. In embodiments, the thiophene additive may be included in an amount of 0.5 wt % to 3 wt % based on a total amount (100 wt %) of the electrolyte for a lithium metal battery. Such embodiments can significantly improve battery lifecycle characteristics, and in particular, lithium metal batteries having a high nickel content.

In some specific embodiments, the thiophene additive may be included in an amount of 1 wt % based on the total amount (100 mol %) of the electrolyte for a lithium secondary battery. In such embodiments wherein the thiophene additive is included within the amounts described herein, lithium metal batteries including a positive electrode having a high nickel content may exhibit improved cycle-life characteristics and stable coulombic efficiency.

In embodiments, the non-aqueous organic solvent may include FSA (fluorosulfonamide). FSA has high compatibility with a lithium metal negative electrode and excellent compatibility with a lithium salt such as, for example, lithium salts including a fluorosulfonyl group. Embodiments comprising an electrolyte that is synthesized using FSA as a solvent can exhibit improved SEI interface characteristics of lithium metal, which can lead to improved durability performance.

In embodiments, the non-aqueous organic solvent may include an ether-based solvent either alone as the non-aqueous organic solvent, or in addition to, or in combination with, FSA. In embodiments, the ether-based solvent may include dipropyl ether, dimethoxy ether, diethyl ether, 1,2-diethoxyethane, cyclopentyl methyl ether, methyl propyl ether, n-butyl methyl ether, ethyl propyl ether, dimethoxymethane, 1,4-dioxane, 1,2,2-tetrafluoroethyl-2,2,3,3-tetrafluoropropyl ether, or a combination thereof.

According to an embodiment, the lithium salt may include at least one of lithium bis(fluorosulfonyl)imide (LiFSI), lithium (fluorosulfonyl) (nonafluorobutanesulfonyl)imide (LiFNFSI), lithium bis(perfluoroethylsulfonyl)imide (LiBETI), and lithium bis(trifluoromethanesulfonyl)imide (LiTFSI), and in some specific embodiments, the lithium salt may be LiFSI.

In embodiments, the concentration of the lithium salt included in the electrolyte for the lithium metal battery may range from 2.0 M to 4.0 M, and in some specific embodiments, from 2.0 M to 3.5 M, 2.0 M to 3.0 M, 2.0 M to 3.4 M, 2.0 M to 3.3 M, or 2.5 M to 3.2 M, including any intermediate values within those ranges.

Without being limited by any proposed mechanisms, it is observed that if the concentration of the lithium salt is below the above range, the conductivity of the electrolyte may decrease, which may result in poor electrolyte performance. Similarly, if the concentration of the lithium salt exceeds the above range, the viscosity of the electrolyte may increase, which may result in reduced mobility of lithium ions and create a problem of overvoltage occurring from the beginning of the cycle. In addition, relating to the SEI layer that is formed on the surface of the lithium metal, (i.e., the negative electrode), is undesirable to not form the layer, or to form too thick of a film, either of which may lower the electrochemical performance of the lithium metal battery.

### <Lithium Metal Battery>

Another aspect of the disclosure provides a lithium metal battery including the electrolyte for a lithium metal battery as described above.

In embodiments, the lithium metal battery may include a positive electrode, a lithium metal layer as a negative electrode that is positioned to face the positive electrode, a separator interposed between the positive electrode and the negative electrode, and the electrolyte for a lithium metal battery in accordance with the disclosure.

In embodiments, the negative electrode for a lithium metal battery may be a lithium metal layer, and the lithium metal layer itself may be used as a negative electrode for a battery. In such embodiments, a battery including such a negative electrode may allow lithium ions from the positive electrode to move to the negative electrode and form a lithium metal layer when charged. Charging and discharging of the battery may comprise forming and/or removing this lithium metal layer.

In embodiments, the negative electrode may be formed on a negative electrode current collector such as copper.

In embodiments, the lithium metal layer may be formed on the negative electrode current collector during the charging and discharging of the lithium metal battery.

In embodiments, the lithium metal layer may have a thickness ranging from 5 μm to 50 μm, for example, 10 μm to 50 μm, or may be formed to have a thickness within the above ranges.

In embodiments wherein the lithium metal layer satisfies the above thickness, side reactions between the lithium metal layer and the electrolyte may be reduced, avoided, or suppressed, thereby improving the electrochemical performance of the lithium metal battery.

In another embodiment, the positive electrode is disposed opposite the negative electrode.

In embodiments, the positive electrode may include a positive electrode current collector and a positive electrode active material layer formed on the positive electrode current collector.

In embodiments, the positive electrode collector may be made of stainless steel, aluminum, nickel, titanium, calcined carbon, or aluminum or stainless steel surface-treated with carbon, nickel, titanium, silver, and the like.

In embodiments, the thickness of the positive electrode collector may be in a range from 3 μm to 500 μm.

In embodiments, the positive electrode active material layer includes a positive electrode active material.

In embodiments, the positive electrode active material may be a compound capable of reversibly intercalating and deintercalating lithium, and in some specific embodiments, may include lithium iron phosphate. In embodiments, wherein the positive electrode active material includes lithium iron phosphate, the compatibility with the aforementioned electrolyte can be increased and/or optimized, so as to maximize improvement in battery performance.

In embodiments, the positive electrode active material may be a compound capable of reversibly intercalating and deintercalating lithium, and in some specific embodiments may include a lithium metal oxide such as, for example, at least one of cobalt, manganese, nickel, and/or aluminum. In further embodiments, the lithium metal oxide may include at least one of a lithium-manganese-based oxide, a lithium-cobalt-based oxide, a lithium-nickel-based oxide, a lithium-nickel-manganese-based oxide, a lithium-nickel-cobalt-based oxide, a lithium-manganese-cobalt-based oxide, a lithium-nickel-manganese-cobalt-based oxide, a lithium-manganese-cobalt-based oxide, and/or a lithium-nickel-cobalt-transition metal (M) oxide.

In embodiments, the positive electrode active material may be a lithium-nickel-manganese-cobalt-based oxide that can suitably improve the capacity characteristics and stability of the battery. In some further embodiments the lithium-nickel-manganese-cobalt-based oxide is represented by Chemical Formula 1:

### [Chemical Formula 1]

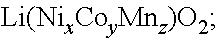

Wherein, in Chemical Formula 1,

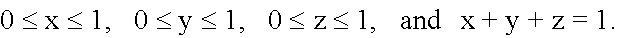

In some example embodiments of Chemical Formula 1, 0.8≤x≤1, 0≤y≤ 1, 0≤z≤1, and x+y+z=1.

In further example embodiments of Chemical Formula 1, 0.89≤x≤1, 0≤y≤1, 0≤z≤1, and x+y+z=1.

Accordingly, in some embodiments, the positive electrode includes a positive electrode active material including a lithium-nickel-manganese-cobalt-based metal oxide, wherein the nickel may be included in an amount of greater than or equal to 80 wt % such as, for example, greater than or equal to 89 wt % based on a total amount (100 wt %) of the positive electrode active material. Typically, positive electrode active material loaded with a high nickel content can exhibit problems of cation mixing, as mentioned above, and additionally, NCM-based particles can exhibit an unstable crystal structure due to position exchange of Li⁺ and Ni²⁺ ions and internal cracks. Prior to the instant disclosure, this typically leads to rapid and easy destruction due to volume changes during the charge/discharge, and also shrink rapidly due to H2 to H3 phase transition at about 4.0 V during the charge, which also increases the structural instability. Prior use of these materials have also shown other disadvantages such as instability of the surface and interface arising from any one or more of electrolyte decomposition, increased surface reactivity, and/or SEI layer instability, as well as electrochemical performance deterioration such as decreased capacity, deteriorated rate characteristics, decreased voltage, and the like.

In contrast to the state of the art, an electrolyte having a composition according to the aspects and embodiments described herein, can improve the cycle-life characteristics of a lithium metal battery having a positive electrode loaded with a high nickel content and a lithium thin film negative electrode. The compositions can overcome the known disadvantages of such materials, as well as improve cycle-life characteristics, which are a typical problem of a conventional lithium metal battery having a positive electrode loaded with a high content nickel and a lithium thin film negative electrode.

In embodiments, the positive electrode active material layer may further include a binder and/or a conductive material.

In embodiments, the separator separates the negative electrode and the positive electrode and provides a passage for lithium ions to move (i.e., a flow path). The separator is not particularly limited as long as it can function as a separator commonly used in lithium secondary batteries.

The following examples illustrate several non-limiting aspects and embodiments of the disclosure in more detail. It will be appreciated that the following examples are merely illustrative of certain exemplary embodiments which are not limiting to the scope of the disclosure or claims.

### (Example) Preparation of Electrolyte for Lithium Metal Battery

An electrolyte is prepared by adding 3 M LiFSl salt to 1,2-dimethoxyethane solvent and dissociating it, and moisture (e.g., water) was removed. To this prepared electrolyte, thiophene also was added in an amount determined according to a weight ratio (see Table 1 below), and the thiophene was dissociated. Subsequently, calcium hydride (CaH₂) (e.g., as dessicant) was added in an amount of 1% or more of a total weight of a sample and then removed by filtration after 30 minutes to finally prepare an electrolyte for a lithium metal battery.

Table 1 summarizes electrolyte compositions for lithium metal batteries according to Examples and Comparative Examples. In Table 1, an amount of the thiophene was based on the total amount of each electrolyte.

TABLE 1

| | LiSI | FSA (volume %) | Thiophene (wt %) |
|---|---|---|---|
| Example 1 | 3M | 100 | 0.5 |
| Example 2 | 3M | 100 | 1 |
| Example 3 | 3M | 100 | 2 |
| Example 4 | 3M | 100 | 3 |
| Comparative Example 1 | 3M | 100 | — |
| Comparative Example 2 | 3.4M | 100 | — |

### (Test Method)

Testing was performed generally as follows:
(1) Initial efficiency of 20 μm Li/Cu cell
   Cell type: 20 μm Li/W-scope separator (19 pi)/Cu, 1.0T spacer, coin type cell (2032)
   Electrolyte injection amount: 10 μl
   Experimental conditions: aging for 1 hour at room temperature (25° C.) and formation charge/discharge current density (0.2 mA·cm⁻²)
(2) 20 μm Li/Cu cell electrodeposited lithium digital photo, SEM images
   Cell type: 20 μm Li/W-scope separator (19 pi)/Cu, 1.0T spacer, coin type cell 2032
   Electrolyte injection amount: 10 μl
   Experiment conditions: aging for 1 hour at room temperature (25° C.), and formation charge current density (0.2 mA·cm⁻²)
   Digital photo and SEM image analysis of lithium electrodeposited on Cu collector
(3) Critical current density evaluation (Li|Li symmetric cell)
   Cell type: 20 μm Li/W-scope separator (19 pi)/Li, 1.0 T spacer, coin type cell (2016)
   Electrolyte injection amount: 10 μl
   Experiment conditions: aging for 1 hour at room temperature (25° C.), formation charge/discharge current density (0.2 mA·cm⁻²), cycle charge/discharge current density (±0.5 mA·cm⁻² (5 cyc), ±1 mA·cm⁻² (5 cyc), ±2 mA·cm⁻² (5 cyc), ±4 mA·cm⁻² (5 cyc)
(4) Evaluation of critical specific capacity (Critical areal capacity, Li|Li symmetric cell)
   Cell type: 20 μm Li/W-scope separator (19 pi)/Cu, 1.0T spacer, coin type cell 2016
   Electrolyte injection amount: 10 μl
   Experiment conditions: aging for 1 hour at room temperature (25° C.), formation charge current density (0.4 mA·cm⁻²), cycle specific capacity (+1 mAh·cm⁻² (5 cyc), ±2 mAh·cm⁻² (5 cyc), ±3 mAh·cm⁻² (5 cyc), ±4 mAh·cm⁻² (5 cyc), ±5 mAh·cm⁻² (5 cyc))
(5) Aurbach Li|Cu cell cycle performance (Li|Cu cell)
   Cell type: 20 μm Li/W-scope separator (19 pi)/Cu, 1.0T spacer, coin type cell 2016
   Electrolyte injection amount: 10 μl
   Experiment conditions: aging for 1 hour at room temperature (25° C.), Li plating (0.2 mA·cm⁻² for 10 hour), Current density (1 mA·cm⁻² for 1 hour (30 cycles)), and Li stripping (0.2 mA·cm-2 for 10 hour)
(6) Evaluation of Li corrosion (Li|Cu cell)
   Cell type: 20 μm Li/W-scope separator (19 pi)/Cu, 1.0T spacer, coin type cell 2016
   Electrolyte injection amount: 10 μl
   Experiment conditions: aging for 1 hour at room temperature (25° C.), formation charge/discharge current density (0.2 mA·cm⁻²), Li plating (0.2 mA·cm⁻² for 10 hour), and 0 V voltage maintenance (for 80 hour)
(7) LSV (Linear sweep voltammetry)
   Cell type: 700 μm Li/W-scope separator (19 pi)/Al bottom, coin type cell 2016
   Experimental conditions: OCV˜6V (1 mV/s) Evaluation
(8) Dark Current Evaluation
   Cell type: 20 μm Li/W-scope separator (16 pi)/High Ni NCM, 1.5T spacer, coin type cell 2032
   Electrolyte injection amount: 10 μl
   Experimental conditions: aging for 1 hour at room temperature (25° C.), 2 cycles of formation charge/discharge (0.1 C, 4.25V/−0.1 C, 3.0V), charging (0.1 C, 4.25V), and 4.25V voltage maintenance for 10 hours.
(9) High-rate Discharge Evaluation
   Cell type: 20 μm Li/W-scope separator (16 pi)/High Ni NCM, 1.5T spacer, coin type cell 2032
   Electrolyte injection amount: 10 μl
   Experimental conditions: aging for 1 hour at room temperature (25° C.), 2 cycles of formation charge/discharge (0.1 C, 4.25 V/−0.1 C, 3.0 V), cycle (1/3 C, 4.25 V/CV: 4.25 V, 0.05 C/−1/3 C, 3.0 V (3 cyc), −1/2 C, 3.0 V (3 cyc), −1 C, 3.0 V (3 cyc), −2 C, 3.0 V (3cyc), −3 C, 3.0 V (3 cyc), −5 C, 3.0 V (3 cyc), −1/3 C, 3.0 V (3 cyc))
(10) After high-rate discharge evaluation, SEM (Scanning Electron Microscope) and EDS (Energy-dispersive X-ray spectroscopy) analysis were performed.
   Cell type: 20 μm Li/W-scope separator (16 pi)/High Ni NCM, 1.5T spacer, coin type cell 2032
   Electrolyte injection amount: 10 μl
   Experimental conditions: After high-rate discharge evaluation, the cells were disassembled and SEM and EDS analyses of the High Ni NCM positive electrode surfaces were performed.
(11) EIS (Electrochemical Impedance Spectroscopy)
   Cell type: 20 μm Li/W-scope separator (16 pi)/High Ni NCM, 1.5T spacer, coin type cell 2032
   Electrolyte injection amount: 10 ul
   Experimental conditions: aging for 1 hour at room temperature (25° C.), and measurement after 1 cycle of formation charge/discharge (0.1 C, 4.25V/−0.1 C, 3.0V)
(12) 20 μm Li/High NI NCM Cell Cycle-life Evaluation
   Cell type: 20 μm Li/W-scope separator (16 pi)/High Ni NCM, 1.5T spacer, coin type cell 2032
   Electrolyte injection amount: 10 μl
   Experimental conditions: 5 hours aging at room temperature (25° C.), 2 cycles of formation charge/discharge (0.1 C, 4.25 V/−0.1 C, 3.0 V), cycle (1/3 C, 4.25 V/CV: 4.25 V, 0.05 C/−1/3 C, 3.0 V/rest 30 min), 1 C=199.3 mAh g⁻¹
   Coulombic efficiency (%): (cycle discharge capacity/cycle charge capacity)×100
(13) 20 μm Li/High NI NCM Cell Cycle-life Evaluation by Amount of Thiophene Additive
   Cell type: 20 μm Li/W-scope separator (16 pi)/High Ni NCM, 1.5 T spacer, coin type cell (2032)
   Electrolyte injection amount: 10 μl
   Experimental conditions: 5 hours aging at room temperature (25° C.), 2 cycles of formation charge/discharge (0.1 C, 4.25 V/−0.1 C, 3.0 V), cycle (1/3 C, 4.25 V/CV: 4.25 V, 0.05 C/−1/3 C, 3.0 V/rest 30 min), 1 C=199.3 mAh g⁻¹
   Coulombic efficiency (%): (cycle discharge capacity/cycle charge capacity)×100

### Experimental Examples

### 1. Cycle-Life Evaluation of 20 μm Li/High Ni NCM Cells by Amount of Thiophene Additive

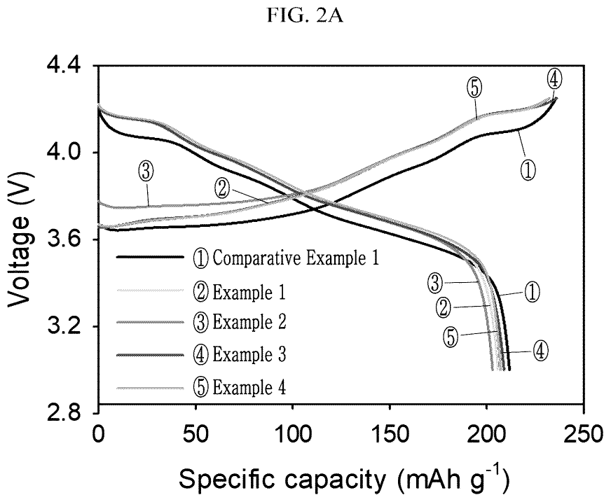

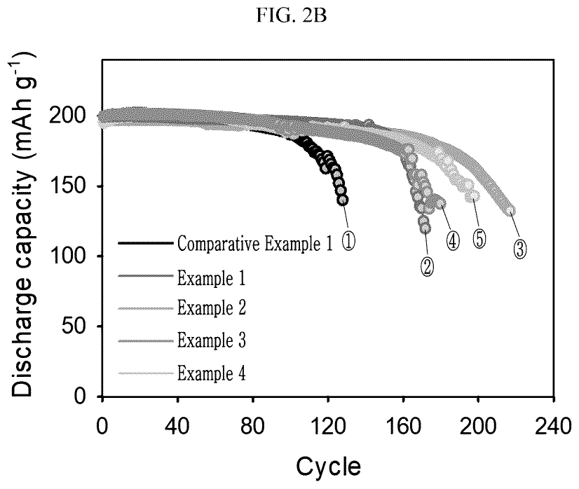

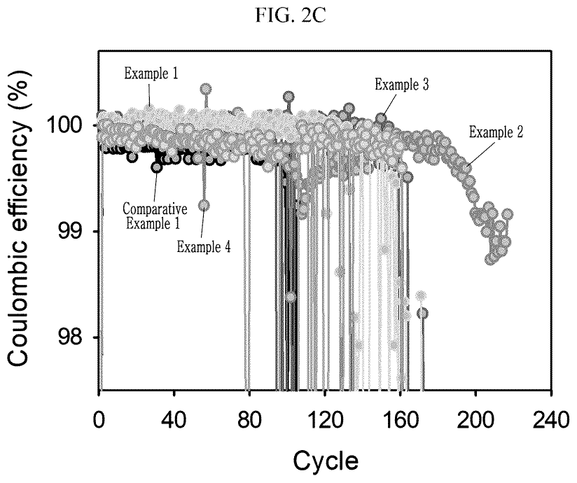

The above evaluation results are shown in FIGS. 2A to 2C and Table 2.

TABLE 2

| | Comparative | Comparative | Example | Example | Example | Example |
|---|---|---|---|---|---|---|
| | Example 1 | Example 2 | 1 | 2 | 3 | 4 |
| Charge capacity | 235.6 | 234.6 | 232.2 | 231.8 | 236.0 | 231.9 |
| (mAh/g) | | | | | | |
| Discharge capacity | 211.7 | 211.1 | 205.7 | 203.0 | 208.9 | 207.2 |
| (mAh/g) | | | | | | |
| ICE (%) | 89.8 | 90.0 | 88.6 | 87.6 | 88.5 | 89.3 |
| Room temperature | 128 | 118 | 168 | 214 | 178 | 186 |
| 25° C. cycle-life | | | | | | |
| (Ret 70%, cyc) | | | | | | |

| | |
|---|---|
| Electrolyte | 1.5 |
| injection amount | |
| (Ah/g) | |

### 2. LSV (Linear Sweep Voltammetry) Evaluation (Al|Li Cell)

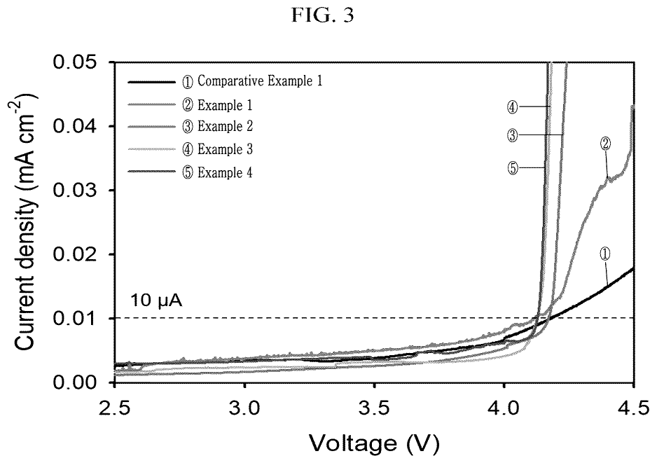

The results of the above evaluation are shown in FIG. 3 and Table 3.

TABLE 3

| | Compar- | | | | |
|---|---|---|---|---|---|
| | ative | Exam- | Exam- | Exam- | Exam- |
| | Example 1 | ple 1 | ple 2 | ple 3 | ple 4 |
| Oxidative decom- | 4.18 | 4.12 | 4.17 | 4.13 | 4.12 |
| position voltage | | | | | |
| (@ 10 μA) | | | | | |

FIGS. 2A to 2C and Table 2 show the results of evaluating a cycle-life of 20 μm Li/High Ni NCM cells respectively using electrolytes into which a thiophene additive was introduced at various amounts from 0.5 to 3 wt %. Comparative Example 1 exhibited a decrease in discharge capacity along with rapid CE shaking after about 100 cycles. In Example 2, the CE shaking phenomenon was controlled, and the cycle-life was significantly improved.

Beyond Example 2, Examples 1, 3, and 4 also exhibited the rapid CE shaking phenomenon around 120 cycles.

Referring to FIG. 3 and Table 3, as the thiophene additive was included in greater amounts, the electrolyte exhibited less oxidation stability, which can generate a rapid oxidation current.

Accordingly, the cycle-life evaluation of the electrolytes at the various amounts of the thiophene additive exhibited varying oxidation stability after 120 cycles due to the difference in cycle-life stability.

Through the testing, the electrolyte composition of Example 2 appeared to exhibit the best performance of the thiophene-containing compositions, each of which improve upon the typical state of the art electrolyte lacking such an additive.

### 3. 20 μm Li/Cu Cell Initial Efficiency

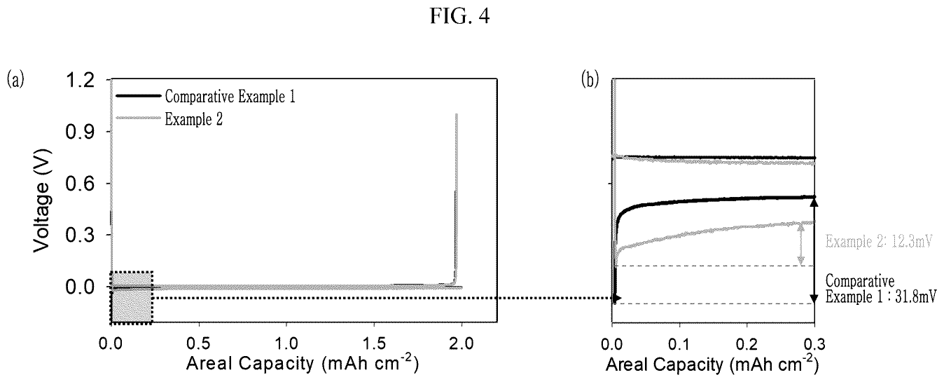

The evaluation results are shown in FIG. 4 and Table 4.

TABLE 4

| | Comparative | |
|---|---|---|
| | Example 1 | Example 2 |
| ICE (%) | 98.7 | 98.5 |
| Electrodeposition overvoltage (mV) | 34.6 | 24.0 |
| Electrodeposition overvoltage - | 31.8 | 12.3 |
| growth overvoltage (mV) | | |

The evaluation was performed to compare performance and lithium ion reversibility of an SEI layer formed by the electrolytes incorporating the thiophene additive.

A graph showing 20 μm Li/Cu cell initial efficiency is provided in a) of FIG. 4. The evaluation was conducted under a condition of 20 μm Li with specific capacity 2 mAh·cm⁻. As a result, Comparative Example 1 exhibited an improved initial efficiency relative to Example 2. This confirmed that Comparative Example 1 exhibited better lithium ion reversibility than Example 2.

However, referring to b) of FIG. 4, the electrolyte into which the thiophene additive was introduced exhibited a decreased overvoltage at which initial lithium was electrodeposited, compared to that of Comparative Example 1 (Comparative Example 1:34.6 mV, Example 2:24.0 mV).

A growth overvoltage occurs during the electrodeposition and growth processes of lithium on a Cu current collector, wherein a smaller difference between electrodeposition overvoltage and growth overvoltage leads to a smoother electrodeposition of the lithium on the Cu current collector. Comparative Example 1 exhibited a difference between electrodeposition overvoltage and growth overvoltage of 31.8 mV, while Example 2 exhibited a significantly reduced overvoltage difference of 12.3 mV.

Furthermore, the incorporation of thiophene additive leads to a smoother electrodeposition of lithium on the Cu current collector in comparison to Comparative Example 1.

### 4. 20 μm Li/Cu Cell Electrodeposited Lithium Digital Photo, SEM Images

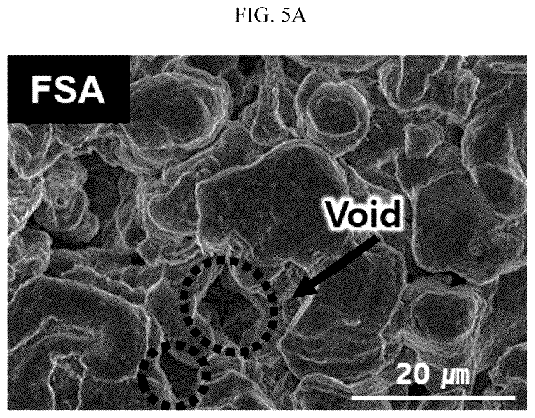

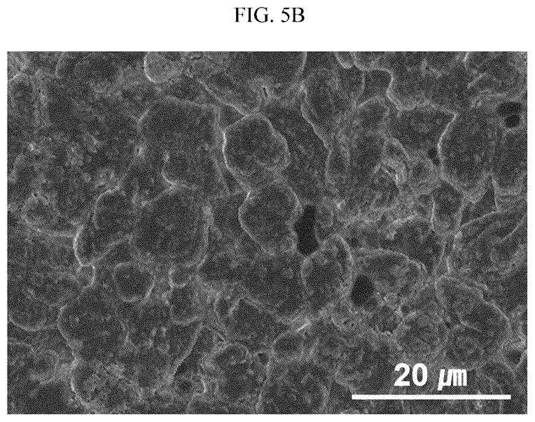

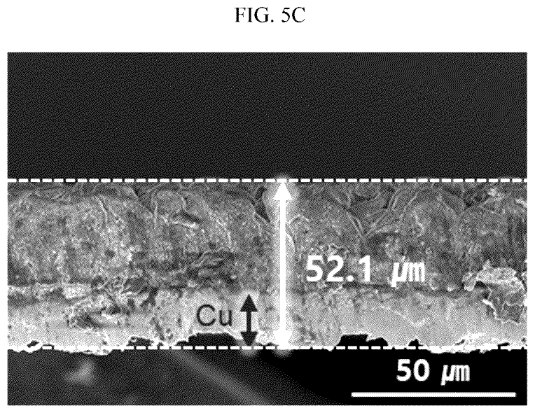

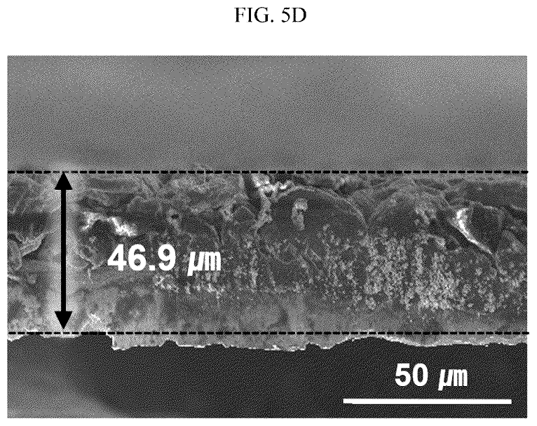

The evaluation results are shown in FIGS. 5A to 5D and Table 5.

TABLE 5

| | Comparative Example 1 | Example 2 |
|---|---|---|
| Li thickness (μm) | 52.1 | 46.9 |

The evaluation was performed by manufacturing 20 μm Li/Cu cells to analyze surface and cross-section SEM images of electrodeposited lithium. FIGS. 5A and 5B show the electrodeposited lithium SEM images of the 20 μm Li/Cu cells respectively using the electrolytes according to Comparative Example 1 and Example 2.

Referring to FIG. 5A, Comparative Example 1 exhibited a void on the electrodeposited lithium surface, and into which the electrolyte may seep causing a problem of a side reaction with lithium. In contrast, referring to FIG. 5B, when 1 wt % of the thiophene additive was introduced, lithium was evenly electrodeposited without any void on the electrodeposited lithium surface. This morphology difference of the electrodeposited lithium had a significant impact on the thickness of the electrodeposited lithium. FIGS. 5C and 5D show the electrodeposited lithium cross-section SEM images of the 20 μm Li/Cu cells, respectively, using the electrolytes according to Comparative Example 1 and Example 2. The electrolyte of Comparative Example 1, which had a void on the surface, thus creating a side reaction with a lithium metal, was confirmed to have a thicker electrodeposited lithium layer than the electrolyte into which the thiophene additive was introduced (Example 2). In contrast, the electrolyte into which the thiophene additive was introduced (Example 2) did not exhibit void formation and did not generate any side reaction with lithium metal, leading to a thinner electrodeposited lithium layer.

Accordingly, the data shows that an SEI (solid electrolyte interphase) layer formed by the electrolyte of Example 2 not only lowers the lithium electrodeposition overvoltage and promote uniform lithium electrodeposition without forming voids, but also suppresses side reactions between electrodeposited lithium and electrolyte, effectively making the lithium electrodeposition thin.

### 5. Evaluation of Critical Current Density (Li|Li Symmetric Cell)

The evaluation results are shown in FIG. 6.

The evaluation compared overvoltages generated by the electrolytes by continuously increasing current density during the cycling process of the lithium symmetric cells (Li|Li symmetric cells).

Through a) of FIG. 6, the composition of Example 2 generated a smaller overvoltage as the cycles progressed after the precycle (0.2 mA·cm⁻²) relative to Comparative Example 1. In particular, b) of FIG. 6 shows the enlarged portion of the graph around 1 mA·cm⁻², which confirmed that the overvoltage of Example 2 was effectively reduced, compared to Comparative Example 1.

The data indicates that the composition of Example 2, including the thiophene additive, exhibited a smaller overvoltage than that of Comparative Example 1, suggesting that the thiophene additive promoted smooth lithium electrodeposition/desorption under conditions of increasing current density. This trend was very similar to the prior results (1 wt % of thiophene formed an SEI (Solid electrolyte interphase) layer to control a side reaction between lithium and electrolyte and promote smooth lithium electrodeposition and growth; initial efficiency of the 20 μm Li/Cu cells and digital photo and SEM images of the electrodeposited lithium of the 20 μm Li/Cu cell).

### 6. Evaluation of Critical Specific Capacity (Critical Areal Capacity, LilLi Symmetric Cell)

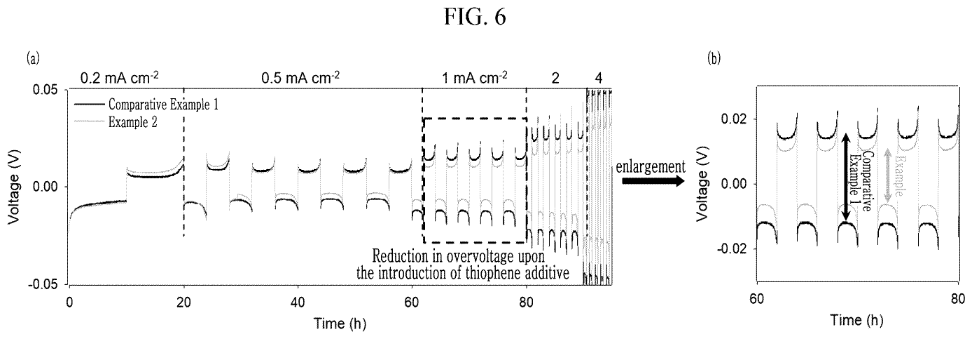

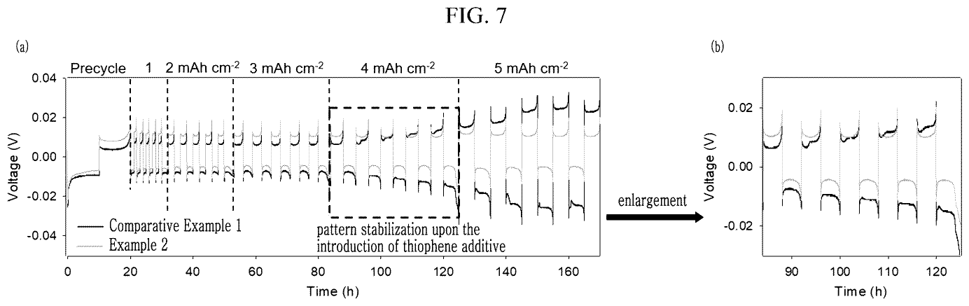

The evaluation result is shown in FIG. 7.

The evaluation compared overvoltages generated by each of the electrolytes by continuously increasing specific capacity during the cycles of the lithium symmetric cells (Li|Li symmetric cells).

Through a) of FIG. 7, the composition of Example 2 generated a higher overvoltage during the precycle and at specific capacity of 1 to 3 mAh·cm⁻² relative to Comparative Example 1. However, even though the specific capacity was increased to 4 mAh·cm⁻², which is specific capacity of a 20 μm Li|High Ni NCM full cell, it was confirmed that the lithium electrodeposition/desorption pattern was stable. In contrast, Comparative Example 1 was confirmed to exhibit unstable lithium electrodeposition/desorption pattern at specific capacity of 4 mAh·cm⁻², which is at a cycle level of a 20 μm Li|High Ni NCM full cell.

Through b) of FIG. 7, the lithium electrodeposition desorption patterns of Comparative Example 1 and Example 2 at specific capacity of 4 mAh·cm⁻² were compared. As discussed, Comparative Example 1 exhibited an unstable lithium electrodeposition/desorption and simultaneously, a continuously increasing overvoltage. However, Example 2 exhibited a stable lithium electrodeposition desorption pattern and was also able to effectively control overvoltage, compared to Comparative Example 1.

The data shows that the electrolyte of Comparative Example 1 exhibited unstable lithium behavior at specific capacity of 4 mAh·cm⁻², which is at a cycle level of a 20 μm Li|High Ni NCM full cell, while Example 2 exhibited a stable lithium electrodeposition/desorption behavior and can effectively control the overvoltage generation.

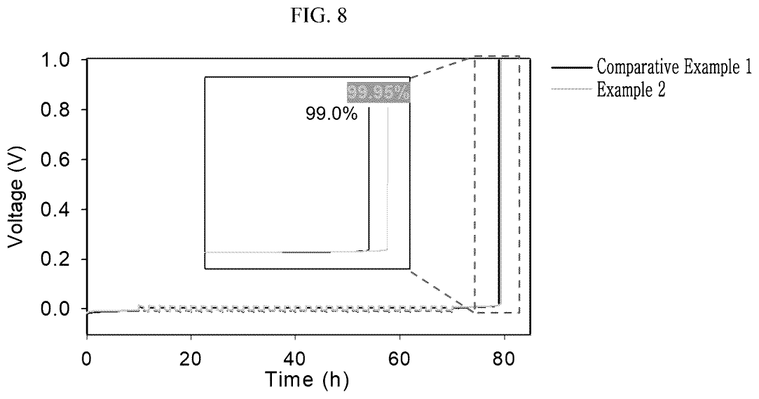

7. Aurbach Li|Cu Cell Cycle Performance (Li|Cu Cell) The evaluation results are shown in FIG. 8 and Table 6.

TABLE 6

| | Comparative Example 1 | Example 2 |
|---|---|---|
| reversible efficiency (%) | 99.0% | 99.95% |

The evaluation was conducted by manufacturing Li|Cu cells to electrodeposit lithium with specific capacity of 2 mAh·cm⁻² on a Cu current collector and then, electrodepositing/desorbing the lithium for 30 cycles at current density of 1 mA·cm⁻², which is at a cycle level of a 20 μm Li|High Ni NCM full cell. Subsequently, lithium reversible efficiency, i.e., when the lithium deposited on the Cu current collector was all desorbed, was compared.

The reversible efficiency (CE_{avg}) was calculated according to the following equation.

$${CE}_{avg} = ( {nQ}_{c} + {Q}_{s} ) / ( {nQ}_{c} + {Q}_{t} ) ;$$

wherein, Q_{c} represents charge capacity for n cycles, Qₛ represents charge capacity at the last stripping, and Qₜ represents capacity of lithium initially electrodeposited on the Cu current collector.

When the reversible efficiency was calculated through the above equation, Comparative Example 1 exhibited reversible efficiency of 99.0%. However, Example 2 exhibited surprising reversible efficiency of 99.95% (refer to FIG. 8 and Table 6).

Accordingly, because an SEI layer formed by the electrolyte of Example 2 effectively increased reversibility of lithium ions, Example 2 exhibited excellent reversible efficiency after the Li|Cu cell cycles, compared to that of Comparative Example 1.

### 8. Evaluation of Li Corrosion (Li|Cu Cell)

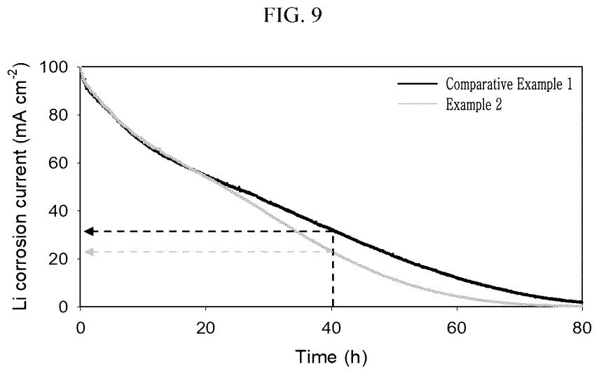

The evaluation results are shown in FIG. 9 and Table 7.

TABLE 7

| | Comparative Example 1 | Example 2 |
|---|---|---|
| Li corrosion current @ 40 h | 32.2 | 23.4 |

The evaluation was conducted by manufacturing Li|Cu cells and aging them for 1 hour at room temperature (25° C.) and then, running a formation cycle (0.2 mA·cm⁻²) to form an SEI layer, electrodepositing lithium at 0 V, and maintaining 0 V for 80 hours. In this testing, Li corrosion degrees were compared by comparing currents flowing therein for the 80 hours.

FIG. 9 is a graph showing the currents flowing for the 80 hours at 0 V in the Li corrosion evaluation (Li|Cu cells). Table 7 compares current density after 40 hours of maintaining 0 V. Comparative Example 1 exhibited current density of about 32.2 m·Acm⁻² after the 40 hours of maintaining 0 V, while Example 2 exhibited current density of 23.4 mA·cm⁻², lower than Comparative Example 1.

The data indicates that when 1 wt % of the thiophene additive was introduced, a stable SEI layer was formed on the lithium metal surface, effectively suppressing any side reaction between lithium metal and electrolyte under the condition of maintaining a voltage at 0 V, while also controlling the Li corrosion phenomenon, and reducing current density generated at that time.

### 9. Evaluation of Dark Current (20 μm Li|High Ni NCM)

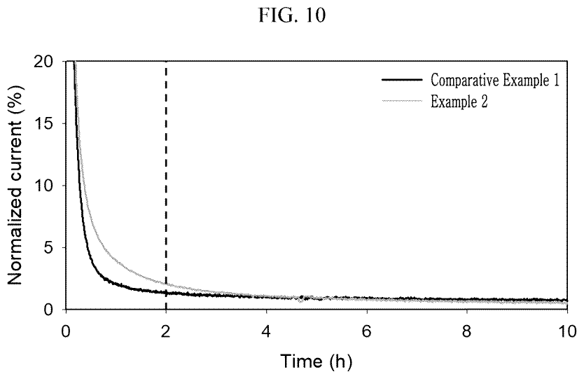

The evaluation results are shown in FIG. 10 and Table 8.

TABLE 8

| | Comparative Example 1 | Example 2 |
|---|---|---|
| Normalized current @ 2 h | 1.36 | 2.12 |

The evaluation determined oxidation stability of the electrolytes much like the previous LSV evaluation.

FIG. 10 graphically compares currents generated by charging the 20 μm Li|High Ni NCM full cells at 4.25 V after the formation cycle and maintaining them at the voltage of 4.25 V for 10 hours. The composition of Example 2 generated a larger amount of current in the beginning, compared to that of Comparative Example 1, which confirmed that the oxidation decomposition of the electrolyte of Example 2 was not controlled, relative to Comparative Example 1.

Table 8 shows currents when the cells were charged at 4.25 V after the formation cycle and maintained at the 4.25 V for 2 hours. As shown in FIG. 10, because the oxidation decomposition of the electrolyte of Example 2 was not controlled, compared to Comparative Example 1, Comparative Example 1 exhibited a current of 1.36%, and Example 2 exhibited a normalized current of 2.12%.

The data indicates that when the thiophene additive was introduced as in the previous LSV evaluation, oxidation stability deteriorated. Furthermore, this indicates that a CEI layer formed by the thiophene additive was unstable at a high voltage.

### 10. Evaluation of High-Rate Discharge (20 μm Li|High Ni NCM)

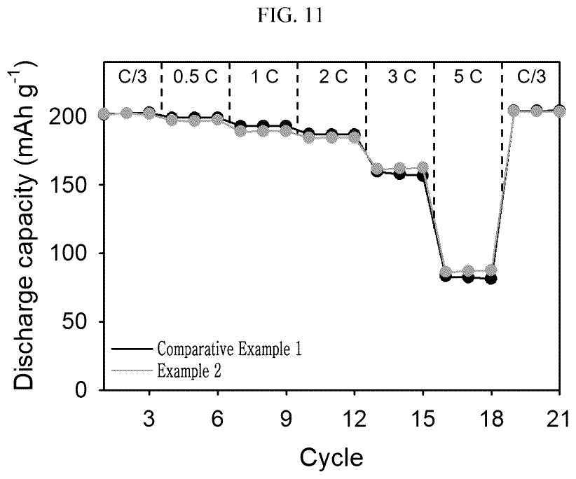

The evaluation results are shown in FIG. 11 and Table 9.

TABLE 9

| | Capacity retention (%) | | | | | |
|---|---|---|---|---|---|---|
| | 0.5 C | 1 C | 2 C | 3 C | 5 C | C/3 |
| Comparative | 98.5 | 95.5 | 92.5 | 78.1 | 40.7 | 100 |
| Example 1 | | | | | | |
| Example 2 | 97.6 | 93.7 | 91.3 | 80.3 | 43.0 | 100 |

A high-rate discharge evaluation was performed to compare ion conductivity of CEI layers formed by the electrolytes. Discharge capacity was compared by fixing a charge cycle at C/3 and gradually increasing a discharge cycle C-rate from C/3 to 5 C. The discharge capacity to formation cycle discharge capacity was generally stable, which confirmed that a side reaction of the electrolyte and the 20 μm Li|High Ni NCM electrode was controlled under the high-rate discharge conditions. Furthermore, the CEI layer formed in a high Ni NCM positive electrode had excellent ionic conductivity, which confirmed that stable performance and behavior is achievable even at a high C-rate.

FIG. 11 and Table 9 show results from a high-rate discharge evaluation (20 μm Li|High Ni NCM). Example 2 exhibited a deteriorated discharge capacity to a C/3 to 2 C-rate, compared to Comparative Example 1. However, Example 2 was more stable at a high-rate discharge of 3 C or more relative to Comparative Example 1, thus exhibiting an excellent capacity retention rate. At the 3 C-rate, in particular, Comparative Example 1 exhibited a capacity retention rate of 78.1%, while Example 2 exhibited a higher capacity retention rate of 80.3%. When the discharge C-rate was increased from 3 C to 5 C, Comparative Example 1 exhibited a capacity retention rate of 40.7%, while Example 2 exhibited significantly improved capacity retention rate of 43.0%.

Accordingly, when the electrolyte composition includes thiophene additive, and particularly about 1 wt % of the thiophene additive, a CEI layer was formed on the lithium metal surface and also, surprisingly, on the high Ni NCM positive electrode surface, each with a high ionic conductivity and capable of achieving a high capacity retention rate at fast C-rates.

### 11. After High-Rate Discharge Evaluation, SEM (Scanning Electron Microscope) and EDS (Energy-Dispersive X-Ray Spectroscopy) Analyses

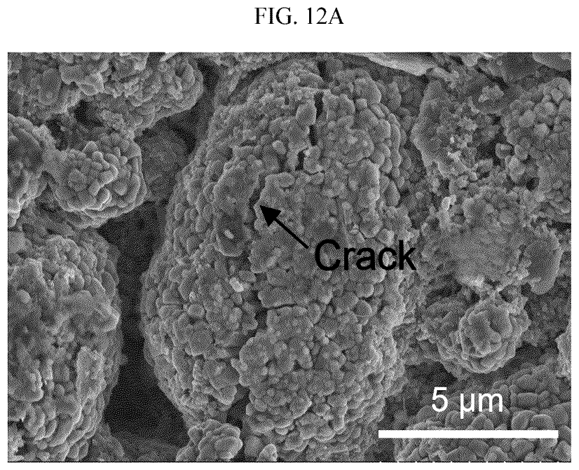

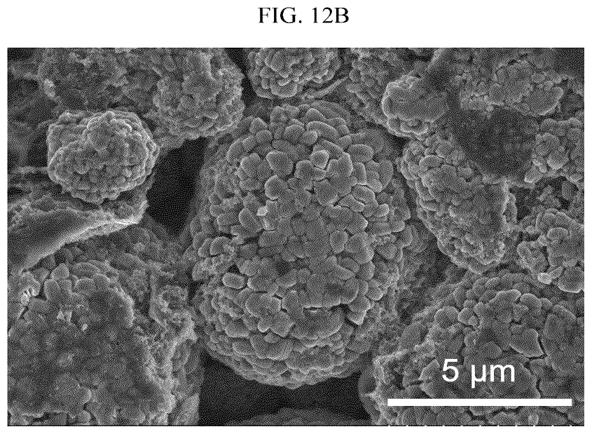

The evaluation results are shown in FIGS. 12A and 12B and Table 10.

TABLE 10

| Wt % | Comparative Example 1 | Example 2 |
|---|---|---|
| C | 29.1 | 28.2 |
| O | 56.9 | 62.9 |
| F | 13.1 | 8.1 |
| S | 0.8 | 0.6 |
| N | 0.3 | 0.2 |

After the high-rate discharge evaluation, SEM (Scanning Electron Microscope) and EDS (Energy-dispersive X-ray spectroscopy) analyses were performed to analyze morphology and components on the high Ni NCM positive electrode surface.

FIG. 12 is an SEM image of the High Ni NCM positive electrode after the high-rate discharge evaluation. FIG. 12A shows the positive electrode surface of the cell using the electrolyte of Comparative Example 1 after the high-rate discharge evaluation. Under the high-rate discharge condition, a side reaction between high Ni NCM positive electrode and electrolyte continuously occurred, resulting in formation of by-products on the positive electrode surface as well as cracks on the surface. Furthermore, when the EDS analysis was performed in parallel with the SEM analysis in order to analyze the surface components, the results indicate (see, e.g., Table 10) that as by-products were formed through a side reaction of 3M FSA and the electrolyte, prominent F and S components were observed.

In contrast, Example 2 was able to achieve an excellent discharge retention rate under the high high-rate discharge condition of the 3 C-rate or higher relative to Comparative Example 1, as well as control any side reaction(s) between electrolyte and high Ni NCM positive electrode, as evidenced by the lack of any crack formation from reaction by-products on the positive electrode surface (FIG. 12B). Because of these effects, the EDS analysis result shows that Example 2 generated less of the F and S components than did Comparative Example 1 (see, Table 10).

Accordingly, the data indicates that when 1 wt % of the thiophene additive is included in the electrolyte, excellent performance is achievable under the high-rate discharge condition of 3 C-rate or higher, and chemical side reactions between electrolyte and electrode are minimized, which results in reduced amounts of by-products on the high Ni NCM surface, and suppressing the formation of surface cracks.

### 12. EIS (Electrochemical Impedance Spectroscopy)

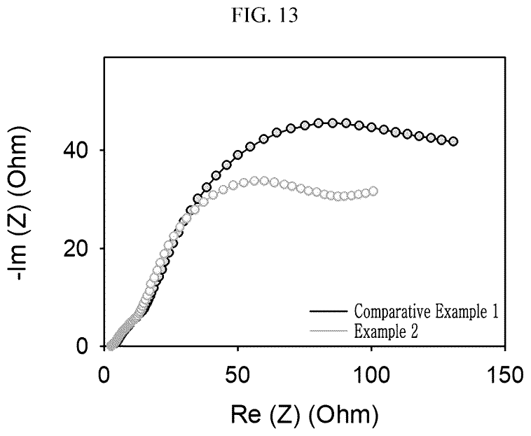

The evaluation results are shown in FIG. 13.

The 20 μm Li|High Ni NCM full cells were subjected to EIS analysis after the formation cycle to determine whether the SEI and CEI layer components formed by the introduction of the thiophene additive had low resistance.

FIG. 13 is a graph depicts results from the EIS analysis. Referring to the data, and in agreement with the previous high-rate discharge evaluation and the SEM and EDS analyses, the components of SEI and CEI layers formed by the electrolyte containing a thiophene additive exhibited low-resistance properties, and significantly reduced interface resistance.

### 13. 20 μm Li/High NI NCM Cell Cycle-Life Evaluation

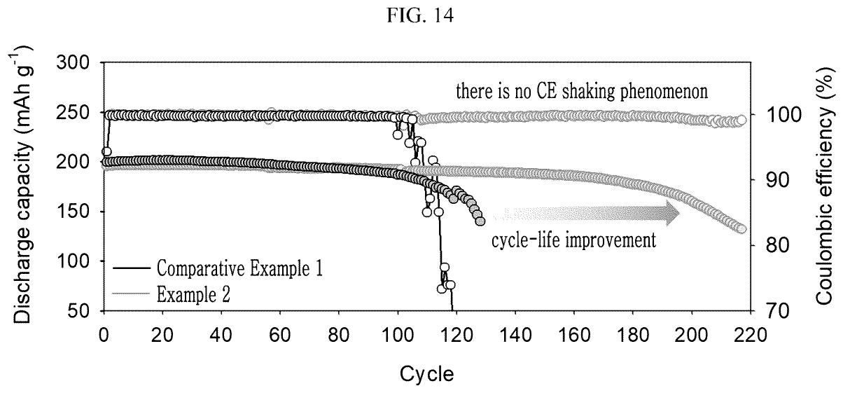

The evaluation results are shown in FIG. 14.

When evaluating cycle-life of the 20 μm Li|High Ni NCM full cells, Comparative Example 1 exhibited deteriorated discharge capacity along with rapid CE shaking after about 100 cycles, whereas Example 2 exhibited more control over the CE shaking phenomenon and a significantly improved cycle-life (see, e.g., FIG. 14).

Comparative Example 1 exhibited a capacity retention rate of 70% at the 128th cycle based on capacity at the formation cycle, while Example 2 exhibited an effective increase in the cycle-life by about 90 cycles.

These experiments demonstrate that, when included in an electrolyte composition, a thiophene additive formed an SEI layer on the lithium metal surface, increasing lithium ion reversibility and controlling any side reaction(s) between electrolyte and lithium metal. Further the additive facilitates the formation of a CEI layer having high ionic conductivity on a High Ni NCM positive electrode surface, exhibiting an excellent discharge retention rate at a high discharge C-rate and effectively reducing interface resistance.

Nevertheless, the data suggests that, when the electrolyte includes a higher weight percent of the thiophene additive (e.g., greater than the ranges described herein, over 3 wt %, over 2 wt %, over 1 wt %), the increased amount of thiophene can cause deterioration in oxidation stability. The illustrative examples suggest that the introduction of less than or equal to 3 wt %, 2 wt %, or in some preferred embodiments less than or equal to 1 wt % of the thiophene additive can be effective or even optimal in overcoming several of the technical challenges associated with the state of the art.

As detailed above, the introduction of a thiophene additive not only stabilizes the interface of a lithium metal but can also improve interface stability of a positive electrode, thereby exhibiting excellent cycle-life stable coulombic efficiency, when compared to a composition that lacks any thiophene additive.

The illustrative examples demonstrate that a lithium metal battery based on a 20 μm lithium thin film and a high-loading high Ni NCM positive electrode, can be produced using a high-loading high Ni NCM positive electrode with an Ni content of about 89% (4 mAh cm-2) and injecting a small amount (1.5 mg mAh-1) of an electrolyte composition according to the disclosure, where the battery exhibits excellent cycle-life performance, and can be used to establish a film characteristic data library.

The electrolyte composition in accordance with the disclosure is capable of stabilizing the lithium metal interface and controlling any side reaction(s) between lithium metal and the electrolyte. This allows for its application as a next generation secondary battery negative electrode material, strengthening future technology-based industries and expanding into markets that can utilize medium and large-sized lithium secondary batteries (e.g., electric power storage and renewable energy industries).

While some illustrative embodiments have been described above, the disclosure is not limited to those particular embodiments, and various modifications may be made to the technology that falls within the scope of the claims and equivalents thereof, the description, and the attached drawings.

What is claimed is:

1. An electrolyte for a lithium metal battery, comprising
a lithium salt;
a non-aqueous organic solvent; and
a thiophene additive;
wherein the thiophene additive is included in an amount of 0.5 wt % to 3 wt % based on a total amount (100 wt %) of the electrolyte.

2. The electrolyte of claim 1, wherein
the thiophene additive is included in an amount of 1 wt % based on a total amount (100 wt %) of the electrolyte.

3. The electrolyte of claim 1, wherein
the non-aqueous organic solvent comprises (FSA).

4. The electrolyte of claim 1, wherein
the lithium salt comprises at least one of lithium bis(fluorosulfonyl)imide (LiFSI), lithium (fluorosulfonyl) (nonafluorobutanesulfonyl)imide (LiFNFSI), and lithium bis(trifluoromethanesulfonyl)imide (LiTFSI).

5. The electrolyte of claim 1, wherein
the lithium salt is at a concentration ranging from 2.0 M to 4.0 M.

6. A lithium metal battery, comprising
a positive electrode;
a negative electrode comprising a lithium metal layer arranged in a position facing the positive electrode;
a separator interposed between the positive electrode and the negative electrode; and
the electrolyte of claim 1.

7. The lithium metal battery of claim 6, wherein
the lithium metal layer has a thickness ranging from 5 μm to 50 μm.

8. The lithium metal battery of claim 6, wherein
the positive electrode comprises a lithium-nickel-manganese-cobalt-based metal oxide.

9. The lithium metal battery of claim 8, wherein
the positive electrode comprises a positive electrode active material including a lithium-nickel-manganese-cobalt-based metal oxide, and
the amount of nickel in the positive electrode active material is greater than or equal to 80 wt % based on a total amount (100 wt %) of the positive electrode active material.

10. The lithium metal battery of claim 9, wherein
the amount of nickel is included in an amount of greater than or equal to 89 wt % based on a total amount (100 wt %) of the positive electrode active material.

11. The lithium metal battery of claim 6, wherein the electrolyte includes the thiophene additive in an amount of 1 wt % based on a total amount (100 wt %) of the electrolyte.

12. The lithium metal battery of claim 7, wherein the electrolyte includes the thiophene additive in an amount of 1 wt % based on a total amount (100 wt %) of the electrolyte.

13. The lithium metal battery of claim 8, wherein the electrolyte includes the thiophene additive in an amount of 1 wt % based on a total amount (100 wt %) of the electrolyte.

14. The lithium metal battery of claim 9, wherein the electrolyte includes the thiophene additive in an amount of 1 wt % based on a total amount (100 wt %) of the electrolyte.

15. The lithium metal battery of claim 10, wherein the electrolyte includes the thiophene additive in an amount of 1 wt % based on a total amount (100 wt %) of the electrolyte.
